(19) United States
(12) Patent Application Publication
(10) Pub. No.: US 2002/0026816 A1
(43) Pub. Date: Mar. 7, 2002

(54) Lockable quick release connection mechanism

(76) Inventors: Mark S. Katsouros, Glenwood, MD (US); Aharon Halevy, Nahariya (IL)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/891,221

(22) Filed: Jun. 26, 2001

Related U.S. Application Data
(60) Provisional application No. 60/214,264, filed on Jun. 26, 2000.

(51) Int. Cl. B62H 5/00

(52) U.S. Cl. 70/233

(57) ABSTRACT

A quick release connection mechanism for pressure connecting a bicycle wheel to the front fork of a bicycle frame includes an axial bolt that can extend through the hub of the wheel and the two prongs of the front fork, a pretension nut connected to a first end of the axial bolt, an operating lever connected to a second end of the axial bolt, a lock bracket positioned around the axial bolt for pressing the prongs against the wheel hub and including a slot aligned with an opening in the lock bracket, and a key lock for locking the operating lever relative to the lock bracket and preventing the operating lever from being activated.

This application claims the benefit of U.S. Provisional Application No. 60/214,264, filed Jun. 26, 2000.

### BACKGROUND OF THE INVENTION

1. Field of the Invention

The present invention relates to mechanisms for pressure connecting two elements together, particularly two parts of a bicycle, yet can be easily manipulated to release the pressure connection and enable quick separation of the two elements. More specifically, this invention relates to such mechanisms which include a locking means to prevent unauthorized release of the pressure connection.

2. The Prior Art

Mechanisms for pressure connecting parts of a bicycle yet which are easily manipulated to release the pressure connection are well known. Such mechanisms often are used to connect a bicycle front wheel to the front fork of the bicycle frame. The quick release feature enables the rider to easily take the front wheel when leaving the bicycle, thus deterring theft. See for example U.S. Pat. No. 5,556,222.

Many mechanisms of this type are constructed to enable the quick release connection mechanism to be locked in its connecting condition and thus prevent separation and theft of either of the parts without the other. This prevents, for example, the front wheel of a bicycle from being removed from the frame, which itself may be locked to an immovable object. See for example U.S. Pat. Nos. 4,028,915, 4,114,409, 4,621,873, 4,724,692, 4,951,487, 5,007,260 and 5,337,587.

The locking means in many of the known quick release connection mechanisms are complicated, requiring many customized parts, and are expensive to produce.

The object of the present invention is to provide a simple and inexpensive lockable quick release connection mechanism that can be used to connect any two elements, but which is especially useful in connecting parts of a bicycle.

### BRIEF DESCRIPTION OF THE DRAWINGS

FIG. 1 shows an exploded perspective view of a preferred quick release connection mechanism according to this invention, shown with a hub of a bicycle wheel and a front fork of a bicycle frame to which the wheel is to be connected;

FIG. 1A is a detail of FIG. 1 showing the key lock used therein;

FIG. 2 is an elevation showing the positioning and orientation of parts of the inventive mechanism when pressure connecting the bicycle wheel to the fork, the protective cover being shown in phantom in an open position;

FIG. 3 is an elevation of the inventive mechanism when in a released orientation; and

FIG. 4 is a view of FIG. 2 as seen along line 4-4 therein.

### DETAILED DESCRIPTION OF THE PREFERRED EMBODIMENT

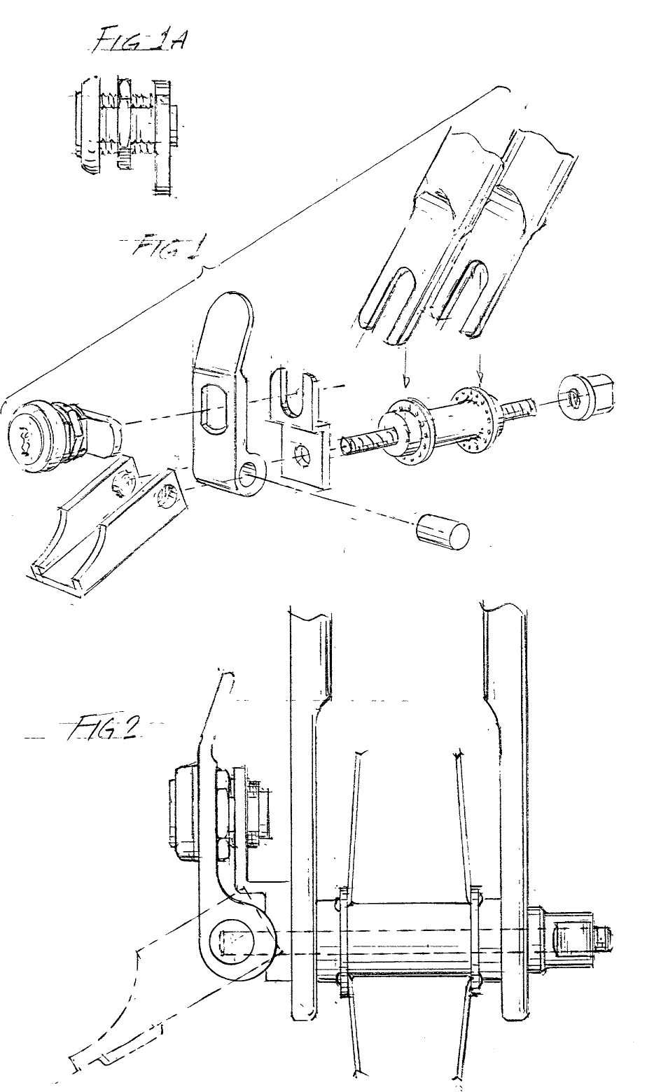

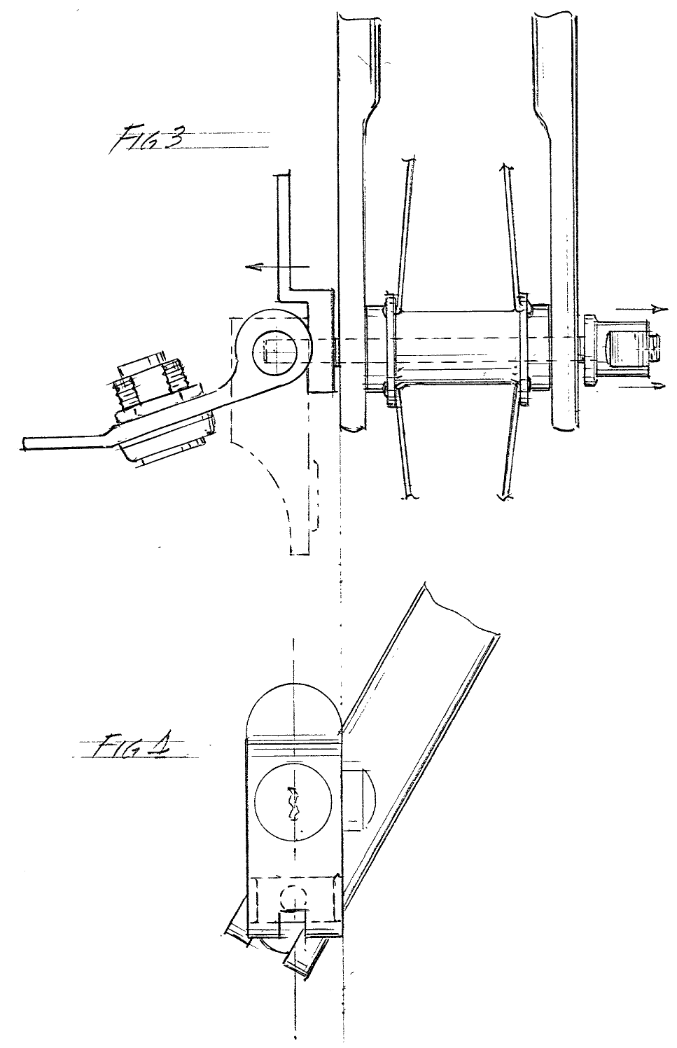

As best seen in FIG. 1, the lockable quick release connection mechanism includes an axial bolt 10 which is shown extending through a hub H of a bicycle wheel, a pretension nut 11 which is adjustably connected to one end of the axial bolt, a lock bracket 12 which includes offset portions 13 and 14 and which is movably positionable along the second end of the axial bolt (the axial bolt extends through a hole 15 in the portion 14), and a operating lever 18 which is connected to the second end of the axial bolt by a core element 22 which is positioned in a lateral through bore 20 in the base 19 of the operating lever, the core element having a threaded blind bore in its side for attachment to the second end of the axial bolt (the base 19 has a hole through which the axial bolt extends). The base 19 is radially contoured so that as it rotates in the channel 17 in the portion 14 of the lock bracket 12 by movement (rotation) of the operating lever from a release orientation (FIG. 3) to a connecting orientation (FIG. 2), the spacing between the lock bracket and the pretension nut 11 will be reduced (cam lock operation). Such a reduction in spacing will press the fork elements f1 and f2 of fork of the bicycle frame against the ends of the hub H and pressure connect the parts together. The rotational positioning of the pretension nut 11 is adjusted prior to movement of the operating lever to achieve proper compression.

When the operating lever 18 is in its connecting orientation (FIG. 2), it is locked in position by a key lock 30 which extends through a complementary-shaped opening 21 in the operating lever and an aligned U-shaped slot 16 in the lock bracket. Locking of the key lock 30 will cause its latch 31 to rotate to a position where it is behind the lock bracket, preventing the operating lever from being moved away from the lock bracket. Thus, the operating lever will not be rotatable to its release orientation and the mechanism will not manually operated to release the pressure connection of the frame elements f1 and f2 to the hub H.

A protective cover 40 which includes ears 41 that fit within the lateral bore 20 of the operative lever 18 to enable the cover to be rotated between a closed-position, where it covers the operating lever 18 and the key lock 30, and an open position (FIG. 2) can used to protect the key lock 30 from damage due to exposure to dirt and impacts.

The quick release connection mechanism of the invention can be used to pressure connect other elements or parts of a bicycle. For example, it can be used to pressure connect a bicycle seat to a bicycle frame by pressure connecting the support tube of the seat within the center tube of the frame.

We claim:

1. A quick release connection mechanism for pressure connecting first and second elements which comprises:
an axial bolt which extends through at least said first element,
a pretension nut which is adjustably connected to a first end of said axial bolt,
an operating lever connected to a second end of said axial bolt and which is movable between a connecting orientation and a release orientation, said operating lever including an opening therethrough,
a lock bracket positioned around said axial bolt between said operating lever and said pretension nut for pressing said second element against said first element, said lock bracket including a slot which is aligned with said opening in said operating lever when in a connecting orientation, and
a key lock which is extendable though said opening in said operating lever and said slot of said lock bracket and operable to lock said operating lever in position relative to said lock bracket and prevent said operating lever from being moved to said release orientation.

2. A quick release connection mechanism according to claim 1, wherein said lock bracket includes first and second offset portions, said first portion including and hole therethrough through which said axial bolt extends and said second portion including a slot which is aligned with said opening in said operating lever.

3. A quick release connection mechanism according to claim 2, wherein said operating lever includes a base which defines a lateral bore therethrough and a core element within said lateral bore for connection to said second end of said axial bolt, and wherein said first portion of said lock bracket defines a channel in which said base of said operating lever rotates as said operating lever is rotates from said connection orientation to said release orientation.

4. A quick release connection mechanism according to claim 3, wherein said key lock includes a rotatable latch.

5. A quick release connection mechanism according to claim 3, wherein said key lock is non-rotatably positioned within said opening.

6. A quick release connection mechanism according to claim 3, including a protective cover which includes ears that extend within opposite ends of said lateral bore of said operating lever and rotatable relative to said operating lever to cover or expose said key lock.
